(19) United States
(12) Patent Application Publication
(10) Pub. No.: US 2025/0244606 A1
(43) Pub. Date: Jul. 31, 2025

(54) EYEGLASS FRAME RETAINING APPARATUS

(71) Applicant: Edward Ingram, Kinston, NC (US)

(72) Inventor: Edward Ingram, Kinston, NC (US)

(21) Appl. No.: 18/423,963

(22) Filed: Jan. 26, 2024

(51) Int. Cl. G02C 3/00; G02C 5/14

(52) U.S. Cl. CPC G02C 3/003; G02C 3/006; G02C 5/143; G02C 2200/02; G02C 2200/20

(57) ABSTRACT

An eyeglass frame retaining apparatus for retaining an eyeglass frame on a user includes a pair of attachments, each comprising a sleeve and a counterweight. The sleeve of each attachment receives and frictionally grips an associated temple of an eyeglass frame, and the counterweight counteracts a movement of the eyeglass frame downwardly and forwardly away from a user wearing the eyeglass frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to eyeglass frame retaining apparatuses and more particularly pertains to a new eyeglass frame retaining apparatus for retaining an eyeglass frame on a user.

### (2) Description of Related Art Including Information Disclosed Under 37 CFR 1.97 and 1.98

The prior art discloses myriad eyeglass frame retaining apparatuses including those which connect to temples of an eyeglass frame and either hook onto an ear or a head of a user or provide a counterweight behind the ear to keep the eyeglass frame from sliding down the user's nose. However, the prior art does not disclose an apparatus which provides a counterweight for releasable attachment to the temple which simultaneously engages the user's body through one or both of a hooking engagement or frictional engagement to prevent the eyeglass frame from slipping. Such an apparatus would be advantageous over the prior art, because, by combining the physical engagement and counterweight functions, the apparatus could use less mass than existing counterweights and have greater functionality over the existing devices utilizing physical engagement. The prior art also does not disclose incorporating magnets into the apparatus to provide the additional function of maintaining ends of a pair of temples of an eyeglass frame together.

### BRIEF SUMMARY OF THE INVENTION

An embodiment of the disclosure meets the needs presented above by generally comprising a pair of attachments, each comprising a sleeve and a counterweight. The sleeve has an open end and a closed end and defines a channel which has a size such that the sleeve is configured for receiving an end of an associated temple of a pair of temples of an eyeglass frame into the channel through the open end. The sleeve comprises a friction material such that the sleeve is configured to secure the sleeve to the associated temple via a friction fit. The friction material is selected to have a coefficient of friction with the associated temple such that the friction fit secures the sleeve to the associated temple. The counterweight is coupled to the closed end of the sleeve and has a mass such that the counter weight is configured to counteract a movement of the eyeglass frame downwardly and forwardly with respect to a user wearing the eyeglass frame when the sleeve is secured to the associated temple and the counterweight is positioned behind an associated ear of a pair of ears of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an eyeglass frame retaining apparatus according to an embodiment of the disclosure.

FIG. 2 is a rear perspective view of an embodiment of the disclosure.

FIG. 3 is a front view of an embodiment of the disclosure.

FIG. 4 is a side view of an embodiment of the disclosure.

FIG. 5 is a front perspective view of an embodiment of the disclosure.

FIG. 6 is a rear perspective view of an embodiment of the disclosure.

FIG. 7 is an in-use view of an embodiment of the disclosure.

FIG. 8 is an in-use view of an embodiment of the disclosure.

FIG. 9 is an in-use view of an embodiment of the disclosure.

FIG. 10 is an in-use view of an embodiment of the disclosure.

FIG. 11 is an in-use view of an embodiment of the disclosure.

### DETAILED DESCRIPTION OF THE INVENTION

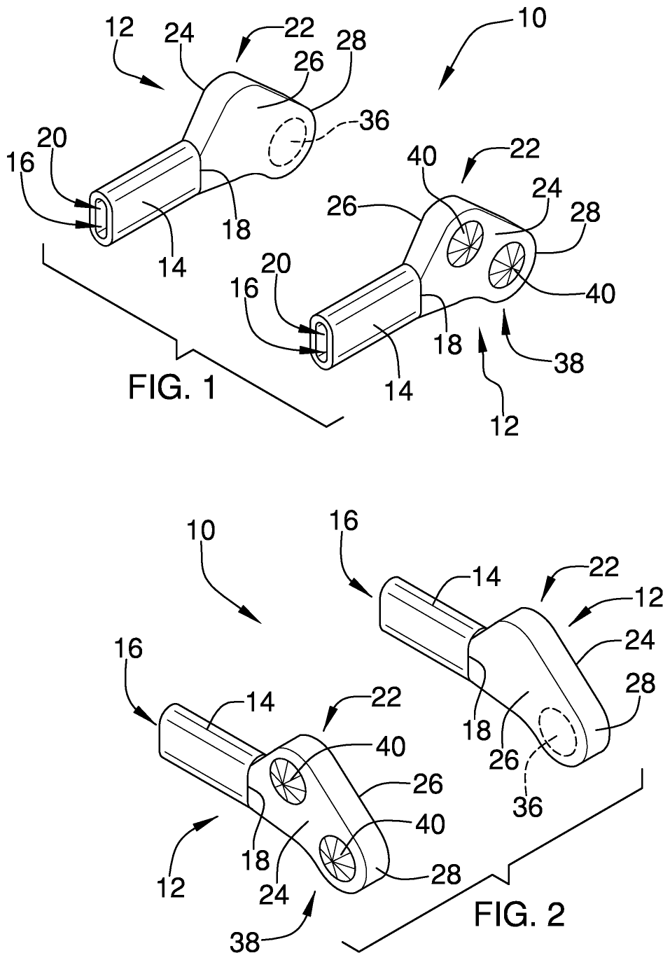

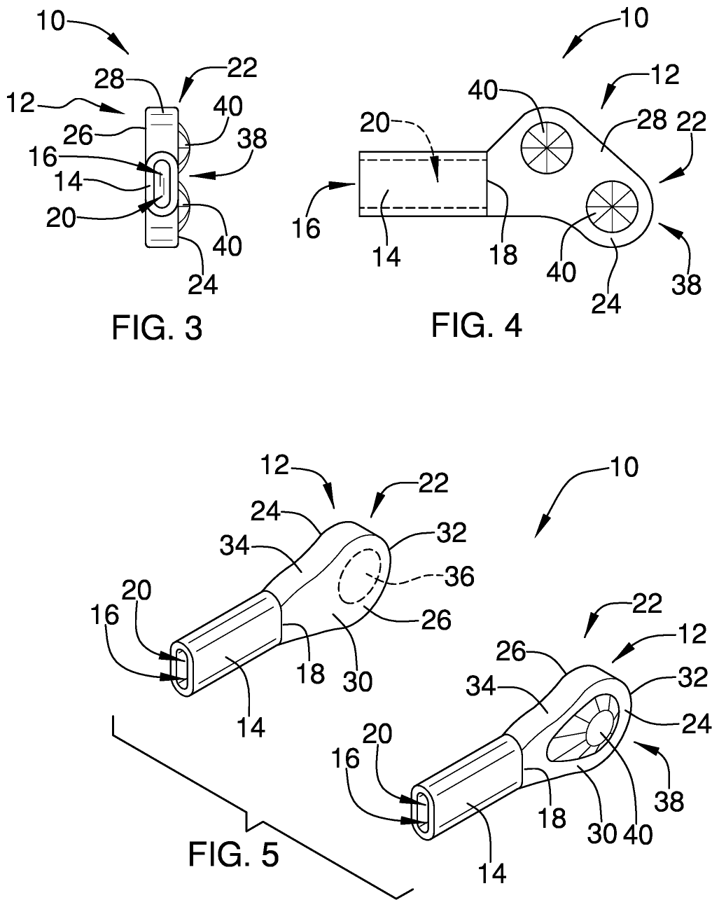

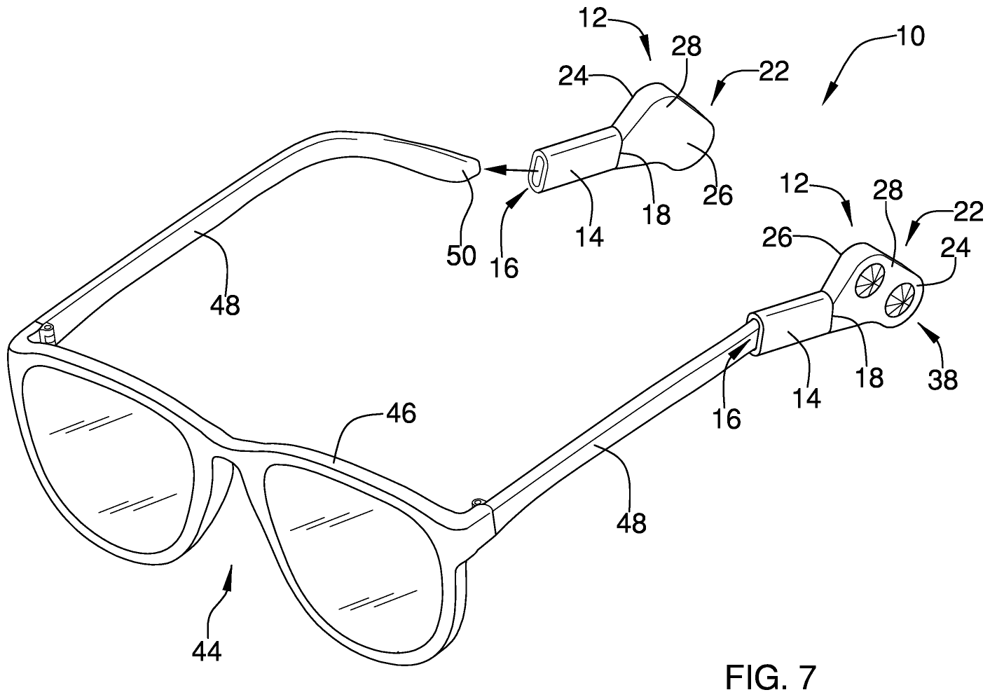

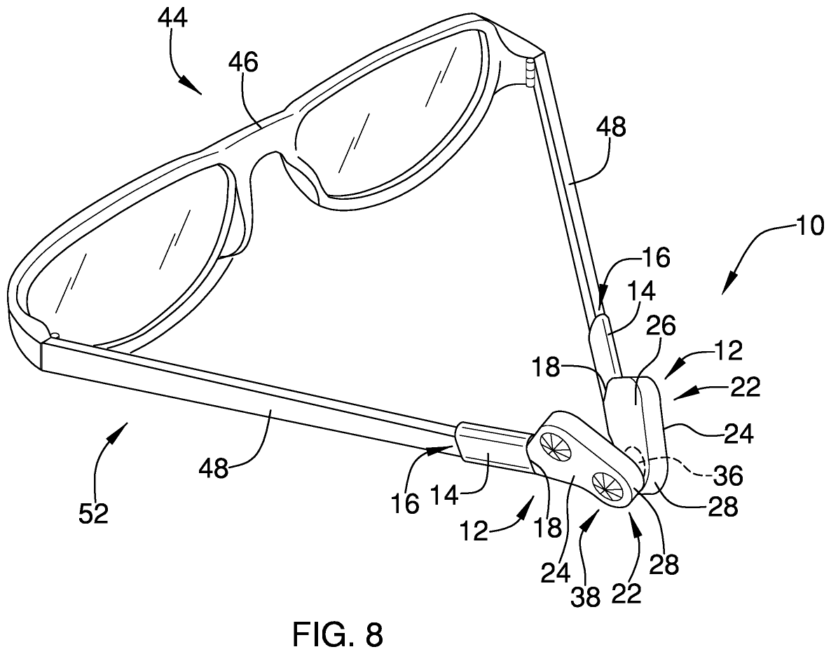

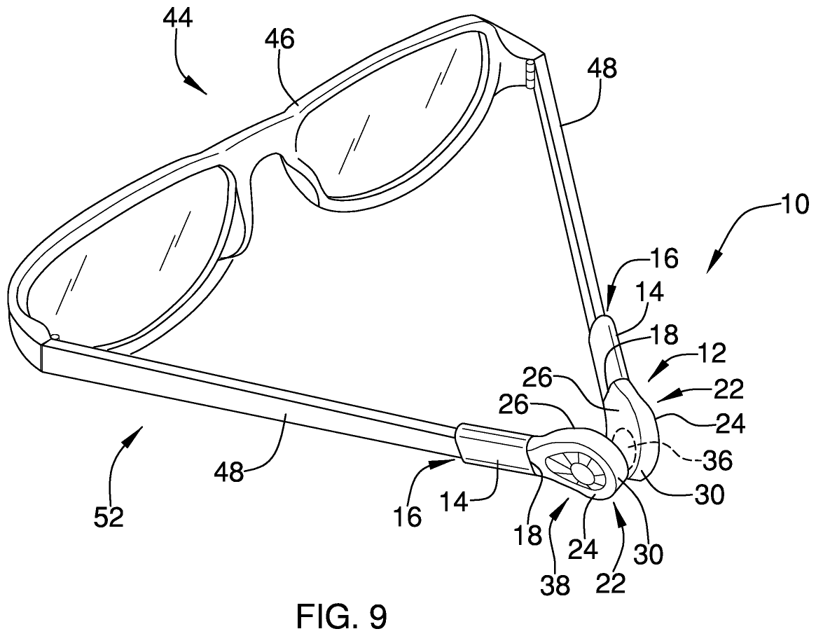

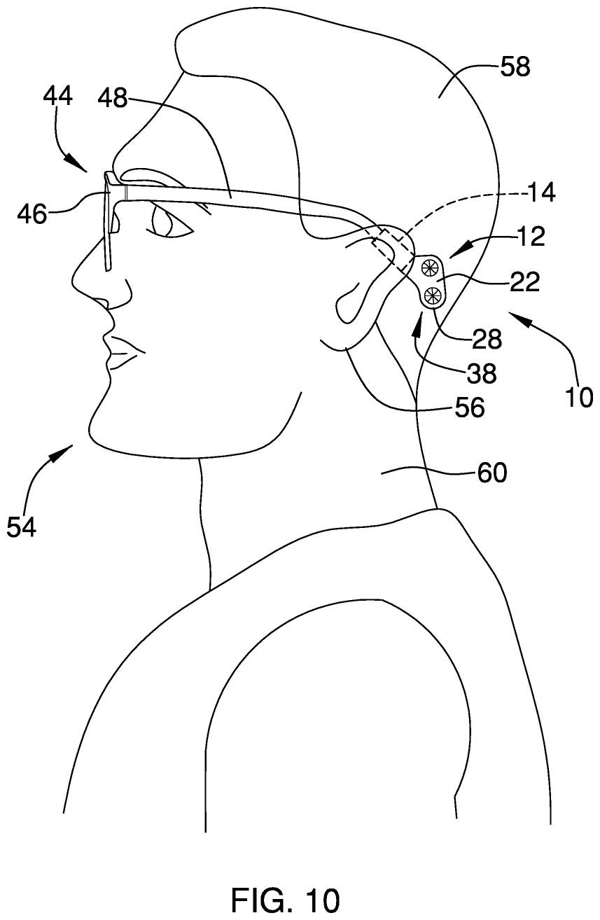

With reference now to the drawings, and in particular to FIGS. 1 through 11 thereof, a new eyeglass frame retaining apparatus embodying the principles and concepts of an embodiment of the disclosure and generally designated by the reference numeral 10 will be described.

As best illustrated in FIGS. 1 through 11, the eyeglass frame retaining apparatus 10 generally comprises a pair of attachments 12 for an eyeglass frame 44. Each attachment 12 of the pair of attachments 12 comprises a sleeve 14, a counterweight 22, a magnet 36, and an ornament 38. The sleeve 14 has an open end 16 and a closed end 18. The sleeve 14 defines a channel 20 which has a size such that the sleeve 14 is configured for receiving an end 50 of an associated temple 48 of a pair of temples 48 of the eyeglass frame 44 into the channel 20 through the open end 16. The sleeve 14 comprises a friction material such that the sleeve 14 is configured to secure the sleeve 14 to the associated temple 48 via a friction fit. The friction material is selected to have a coefficient of friction with the associated temple 48 such that the sleeve 14 is secured to the associated temple 48 via the friction fit. The friction material comprises rubber but may comprise any suitable material for establishing the friction fit. The friction material is also resiliently flexible such that the sleeve 14 is configured to conform to the associated temple 48.

The counterweight 22 is coupled to the closed end 18 of the sleeve 14. The counterweight 22 has a mass such that the counter weight is configured to counteract a movement of the eyeglass frame 44 downwardly and forwardly with respect to a user 54 wearing the eyeglass frame 44 when the sleeve 14 is secured to the associated temple 48 and the counterweight 22 is positioned behind an associated ear 56 of a pair of ears 56 of the user 54. The counterweight 22 has a width configured to be greater than a width of the associated temple 48 such that the counterweight 22 is configured to engage the user 54 to prevent the movement of the eyeglass frame 44. The counterweight 22 may engage the user 54 by hooking around one or both of the associated ear 56 and a head 58 of the user 54. The counterweight 22 may also frictionally engage the user 54 to prevent the counterweight 22 from sliding across the user 54.

The magnet 36 of each attachment 12 member is embedded in the counterweight 22. The magnet 3s of the pair of attachments 12 are configured to retain the ends 50 of the pair of temples 48 together when the pair of attachments 12 are secured to the pair of temples 48 and the ends 50 of the pair of temples 48 are positioned adjacent to each other. Retaining the ends 50 of the pair of temples 48 together in this fashion allows for the eyeglass frame 44 to be set on a support surface in a substantially triangular shape 52 defined by the pair of temples 48 and a lens holding section 46. Setting the eyeglass frame 44 down in the triangular shape 52 may be desirable to some as an alternative to a folded configuration, for example, because folded configurations may be more easily knocked over. Moreover, lenses held by the eyeglass frame 4s may be more exposed in a folded configuration versus the triangular shape 52 and thus more prone to damage or soiling from fingers or the like.

The counterweight 22 of each attachment 12 member has a first face 24 and a second face 26 positioned opposite to each other and oriented parallel to each other. An ornament 38 is coupled to the first face 24 of the counterweight 22. The counterweight 22 is positionable when the sleeve 14 is secured to the associated temple 48 such that the first face 24 faces away from the user 54, thus displaying the ornament 38. The ornament 38 may contain one or more gems 40 tones, beads, printed designs, or other aesthetically pleasing matter.

FIGS. 1-4, 7, 8, and 10 depict embodiments in which the counterweight 22 of each attachment 12 has an oblong shape 28, and the counterweight 22 extending transversely to a central axis of the sleeve 14 extending from the open end 16 to the closed end 18.

Referring to FIGS. 5, 6, 9, and 11, the counterweight 22 of each attachment 12 of some embodiments has a teardrop shape 30, wherein a rounded portion 32 of the teardrop shape 30 is positioned distally from the sleeve 14 and a tapering portion 34 of the teardrop shape 30 tapers from the rounded portion 32 to the sleeve 14.

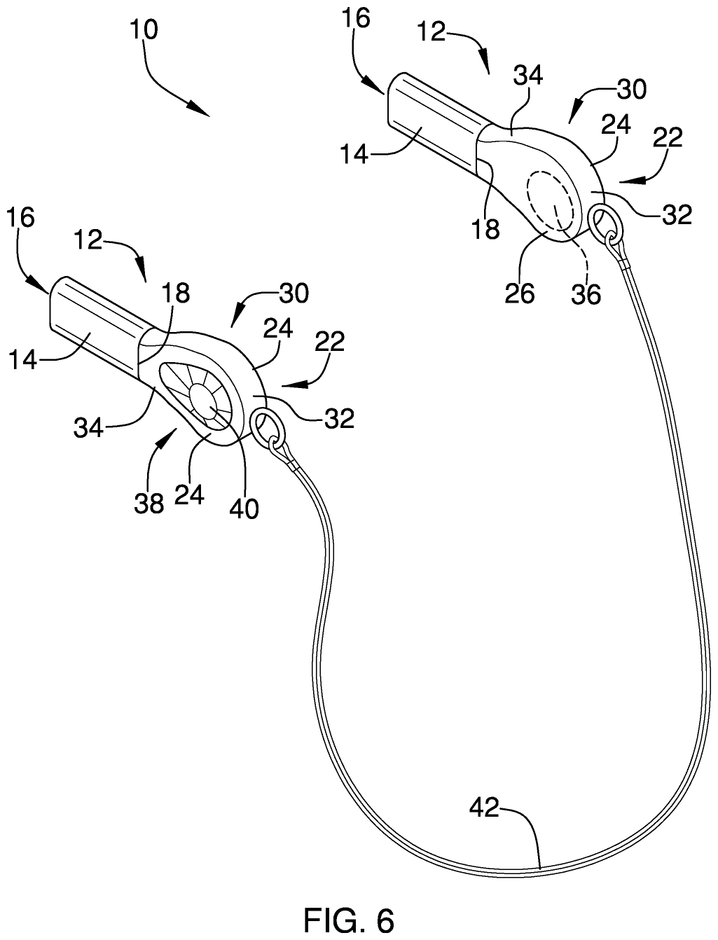

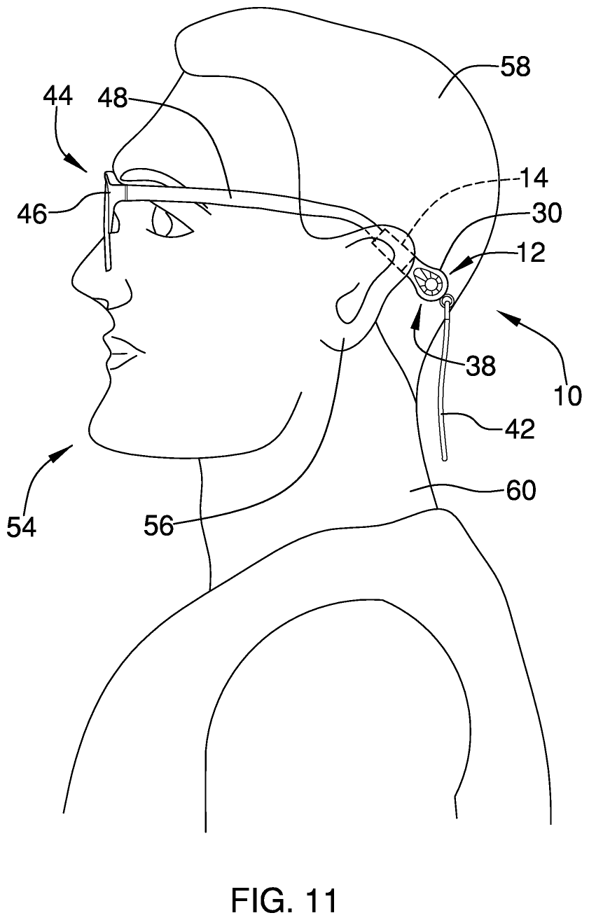

In FIGS. 6 and 11, embodiments are seen which comprise a neck strap 42 coupled to and extending between the pair of attachments 12. The neck strap 42 is configured to hang the eyeglass frame 44 on a neck 60 of the user 54 and may also serve to maintain the attachments 12 together when the attachments 12 are not secured to the eyeglass frame 44.

In use, the attachments 12 are secured to the ends 50 of the temples 48 of the eyeglass frame 44 as described above. The counterweight 2s counteract forces, such as the gravitational force, which urge the eyeglass frame 44 forwardly and downwardly away from the user 54 by facilitating the exertion of a leveraging gravitational force opposite the user's 54 ears 56. The counterweight 2s of the attachments 12 further prevent slippage of the eyeglass frame 44 away from the user 54 by engaging through one or both of normal contact or friction with the user 54. The neck strap 42 may also serve to maintain the eyeglass frame 44 near the user 54 in the event the eyeglass frame 44 slips off of the ears 56 of the user 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An eyeglass frame retaining apparatus comprising a pair of attachments, each attachment of the pair of attachments comprising:
a sleeve having an open end and a closed end, the sleeve defining a channel which has a size such that the sleeve is configured for receiving an end of an associated temple of a pair of temples of an eyeglass frame into the channel through the open end, the sleeve comprising a friction material such that the sleeve is configured to secure the sleeve to the associated temple via a friction fit; and
a counterweight being coupled to the closed end of the sleeve, the counterweight having a mass such that the counter weight is configured to counteract a movement of the eyeglass frame downwardly and forwardly with respect to a user wearing the eyeglass frame when the sleeve is secured to the associated temple and the counterweight is positioned behind an associated ear of a pair of ears of the user.

2. The apparatus of claim 1, wherein the friction material comprises rubber.

3. The apparatus of claim 1, wherein the friction material is resiliently flexible such that the sleeve is configured to conform to the associated temple.

4. The apparatus of claim 1, wherein the counterweight has a width configured to be greater than a width of the associated temple such that the counterweight is configured to engage the user to prevent the movement of the eyeglass frame.

5. The apparatus of claim 1, wherein:
each attachment of the pair of attachments further comprises a magnet being coupled to the counterweight; and
the magnets of the pair of attachments are configured to retain the ends of the pair of temples together when the pair of attachments are secured to the pair of temples and the ends of the pair of temples are positioned adjacent to each other.

6. The apparatus of claim 1, wherein the counterweight of each attachment of the pair of attachments has a first face and a second face positioned opposite to each other and being oriented parallel to each other, each attachment of the pair of attachments further comprising an ornament being coupled to the first face of the counterweight, wherein the counterweight is positionable when the sleeve is secured to the associated temple such that the first face faces away from the user.

7. The apparatus of claim 1, wherein the counterweight of each attachment of the pair of attachments has an oblong shape, the counterweight extending transversely to a central axis of the sleeve extending from the open end to the closed end.

8. The apparatus of claim 1, wherein the counterweight of each attachment of the pair of attachments has a teardrop shape, a rounded portion of the teardrop shape being positioned distally from the sleeve, a tapering portion of the teardrop shape tapering from the rounded portion to the sleeve.

9. The apparatus of claim 1, further comprising a neck strap being coupled to and extending between the pair of attachments, the neck strap being configured to hang the eyeglass frame on a neck of the user.

10. An eyeglass frame retaining apparatus comprising:
a pair of attachments, each attachment of the pair of attachments comprising:
a sleeve having an open end and a closed end, the sleeve defining a channel which has a size such that the sleeve is configured for receiving an end of an associated temple of a pair of temples of an eyeglass frame into the channel through the open end, the sleeve comprising a friction material such that the sleeve is configured to secure the sleeve to the associated temple via a friction fit, the friction material comprising rubber, the friction material being resiliently flexible such that the sleeve is configured to conform to the associated temple;
a counterweight being coupled to the closed end of the sleeve, the counterweight having a mass such that the counter weight is configured to counteract a movement of the eyeglass frame downwardly and forwardly with respect to a user wearing the eyeglass frame when the sleeve is secured to the associated temple and the counterweight is positioned behind an associated ear of a pair of ears of the user, the counterweight having a width configured to be greater than a width of the associated temple such that the counterweight is configured to engage the user to prevent the movement of the eyeglass frame, the counterweight having a first face and a second face positioned opposite to each other and being oriented parallel to each other;
a magnet being embedded in the counterweight; and
an ornament being coupled to the first face of the counterweight, wherein the counterweight is positionable when the sleeve is secured to the associated temple such that the first face faces away from the user;
wherein the magnets of the pair of attachments are configured to retain the ends of the pair of temples together when the pair of attachments are secured to the pair of temples and the ends of the pair of temples are positioned adjacent to each other.

11. The apparatus of claim 10, wherein the counterweight of each attachment of the pair of attachments has an oblong shape, the counterweight extending transversely to a central axis of the sleeve extending from the open end to the closed end.

12. The apparatus of claim 10, wherein the counterweight of each attachment of the pair of attachments has a teardrop shape, a rounded portion of the teardrop shape being positioned distally from the sleeve, a tapering portion of the teardrop shape tapering from the rounded portion to the sleeve.

13. The apparatus of claim 12, further comprising a neck strap being coupled to and extending between the pair of attachments, the neck strap being configured to hang the eyeglass frame on a neck of the user.
